(19) United States
(12) Patent Application Publication
(10) Pub. No.: US 2011/0139945 A1
(43) Pub. Date: Jun. 16, 2011

(54) PORTABLE CHARACTERIZED, THEMED AUDIO/VIDEO MEDIA PLAYER HOLDER

(76) Inventors: Beatriz Fahrberger, Tracy, CA (US); Louis Fahrberger, Tracy, CA (US)

(21) Appl. No.: 12/636,590

(22) Filed: Dec. 11, 2009

(51) Int. Cl. F16M 13/00; F16B 47/00

(52) U.S. Cl. 248/121; 248/309.1; 248/288.11; 248/205.1; 248/206.2; 248/226.11; 248/314

(57) ABSTRACT

A portable electronic device holder adaptable to hold at least one electronic device is disclosed. The electronic device holder comprises of a media holder for securing the at least one electronic device therein, a themed component adaptable to receive the media holder and an attachment means for allowing the electronic device holder to fit against a surface. The themed component designed as a favorite character provides a friendly appearance to the portable electronic device holder and entertainment to a user. The media holder includes at least one base portion configured to hold an external speaker system that plugs into the electronic device. The themed component includes at least one pocket for receiving at least one arm portion of the media holder. The attachment means is designed to connect with the media holder thereby allowing the media player to fit firmly onto the themed component.

### CROSS-REFERENCE TO RELATED APPLICATION

None

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates in general to portable electronic device holders, and more particularly to an improved portable electronic device holder with a themed character for providing friendly appearance and entertainment.

Electronic device holders have been available in a variety of different styles and designs in the market. The device holders safely secure electronic devices like music players, iPhones, iPods, personal digital assistants (PDAs) from shocks, shakes, bounces and other accidental jarring. Most commonly, these device holders are manufactured specially for applications inside automobiles for securing entertainment systems within the vehicles. There aren't portable device holders that allow users to carry the electronic devices everywhere they go.

Several device holders for securing media devices have been developed in the art. For example, U.S. patent application No. 2009/0060473 to Kohte on Mar. 5, 2009 provides a portable, flexible, soft aluminum rod for holding portable media players using two clamps. The device provides an improved viewing experience as it adjusts an electronic device both horizontally and vertically with a ball and socket joint behind the clamp.

Another prior art taught in U.S. Pat. No. 7,099,467 issued to Rohrbach on Aug. 29, 2006 discloses an apparatus that can secure an electronic device and adaptable to insert into a conventional cup holder. The cup holder is positioned inside of an automobile. The electronic device being held can be a variety of devices that include a digital music player. Adapting sleeves that fit around the base of the apparatus can be used to adapt an electronic device holder to cup holders of different sizes and shapes.

U.S. Pat. No. 6,366,672 issued to Tsay on Apr. 2, 2002 discloses an improved mobile phone holder that includes a phone seat body adapted for clamping and holding a mobile phone, an adapter seat adapted for electrical connection with a car's power source, and a receiving seat. The receiving seat is replaceable with ones having different connectors to adapt to different models of mobile phones.

Most of the above devices for holding electronic devices have considerable drawbacks. Such devices do not provide a friendly appearance and an aesthetic look. Further, these devices are specifically designed for adults and are not attractive to children. Such devices have mounting means with lengthy cables that may cause discomfort to users. Moreover, such devices require complex mounting means for attaching the electronic device holders on a surface.

It is therefore, an object of the present invention to provide an electronic device holder having a friendly appearance that renders entertainment to small children, adolescents and adults. Another object of the invention is to provide an easy and hands free device holder with a simple and adjustable mounting means. Other objects of the present invention will become better understood with reference to appended Summary, Description and Claims.

### SUMMARY

The present invention is a portable electronic device holder adaptable to hold at least one electronic device. The electronic device holder comprises a media holder for securing at least one electronic device therein, a themed component adaptable to receive the media holder and an attachment means connected to the media holder for allowing the portable electronic device holder to fit against a surface. The themed component is designed as a favorite character and provides a friendly appearance to the portable electronic device holder. The media holder incorporated to the electronic device holder includes at least one arm portion that is adjustable to hold the at least one electronic device. The media holder further includes at least one neck portion designed to bend into multiple positions thereby providing an easy view of the at least one electronic device from different angles. The media holder further includes at least one base portion configured to hold an external speaker system that plugs into the at least one electronic device.

The attachment means of the electronic device holder includes at least one base area that allows the portable electronic device holder to fit firmly against a surface. The themed component includes at least one pocket for receiving the at least one arm portion of the media holder. The themed component further includes at least one slit that is adaptable to receive at least one top area of the attachment means. The at least one top area of the attachment means is adaptable to connect with a back portion of the media holder thereby allowing the media player to fit firmly onto the themed component.

Although particular embodiments of the present invention have been described in the foregoing description, it is to be understood that the present invention is not to be limted to just the embodiments disclosed, but that they are capable of numerous rearrangements, modifications and substitutions without departing from the description herein.

### FIGURES

FIG. 1 is a perspective view of the present invention.

FIG. 2 is a front view of the present invention, illustrating a portable electronic device holder adaptable to hold at least one electronic device therein.

FIG. 3 is a perspective view of the present invention, illustrating a themed component of a portable electronic device holder and an attachment means for allowing the electronic device holder to fit against a surface.

FIG. 4 is a perspective view of at least one base portion of a media holder of the present invention.

FIG. 5 is a perspective view of at least one base portion of a media holder of the present invention, illustrating an external speaker system.

FIG. 6 is a perspective view of an attachment means of the present invention.

FIG. 7 is a rear view of a media holder detached from an attachment means of the present invention.

### REFERENCE NUMERALS

10 . . . A portable electronic device holder

12 . . . A media holder

14 . . . At least one electronic device

16 . . . A themed component

18 . . . An attachment means 20 . . . At least one arm portion 22 . . . At least one neck portion 24 . . . At least one base portion 26 . . . At least one pocket 28 . . . At least one slit 30 . . . At least one top area 32 . . . A mid section of the teddy bear 34 . . . A top surface 36 . . . A rubber portion 38 . . . An external speaker system 40 . . . At least one mini-speaker 42 . . . At least one speaker wire 44 . . . A canal 46 . . . A plug 48 . . . At least one base area

50 . . . A back portion

52 . . . A connecting area

### DESCRIPTION

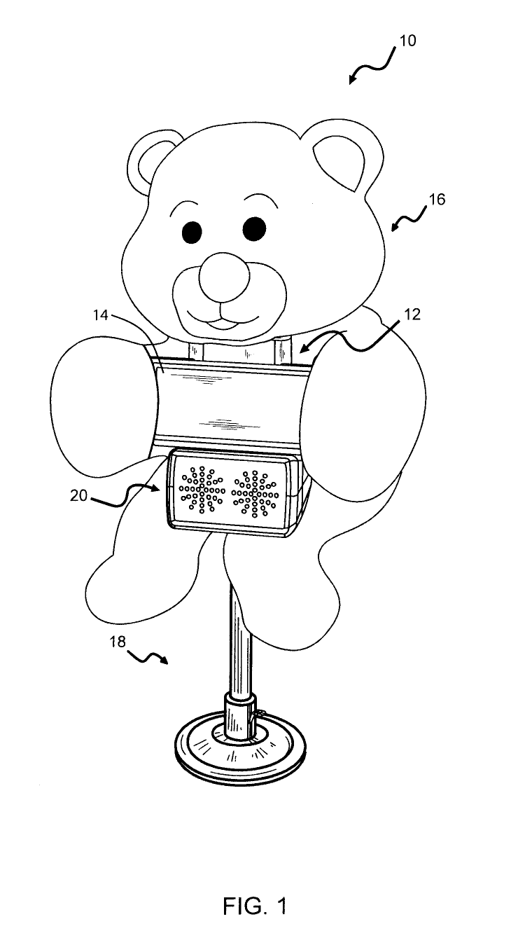

Referring to the drawings, a preferred embodiment of a portable electronic device holder is illustrated and generally indicated as 10 in FIGS. 1 through 6. Referring to FIG. 1, the portable electronic device holder 10 comprises a media holder 12 for securing at least one electronic device 14, a themed component 16 adaptable to receive the media holder 12 and an attachment means 18 connected to the media holder 12 for allowing the portable electronic device holder 10 to fit against a surface. The themed component 16 may be a favorite character for providing a friendly appearance to the electronic device holder 10 and entertainment to at least one user.

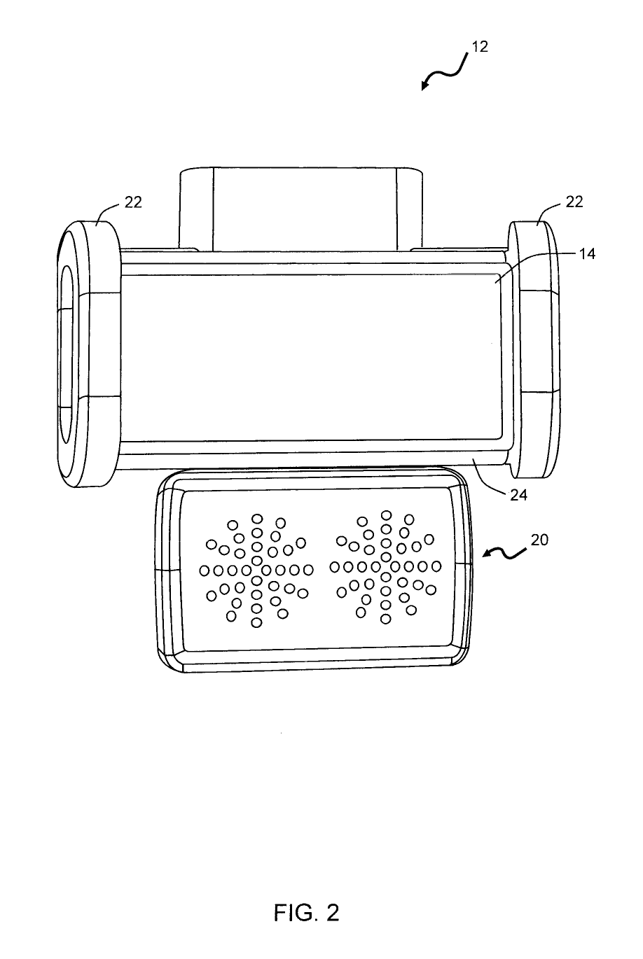

FIG. 2 illustrates a front view of a portable electronic device holder 10 adaptable to hold at least one electronic device 14 therein. A media holder 12 of the electronic device holder 10 includes at least one arm portion 20 that is adjustable to hold different sized electronic devices of choice. The media holder 12 further includes at least one neck portion 22 designed to bend into multiple positions thereby providing an easy view of the at least one electronic device 14 from different angles. The media holder 12 further includes at least one base portion 24 that supports the at least one electronic device 14 thereon. The at least one electronic device 14 may be attached to the media holder 12 by means of an adhesive, Velcro hook, loop fastener, etc. (not shown). The at least one electronic device 14 may be a media player, iPod, cell phone or the like.

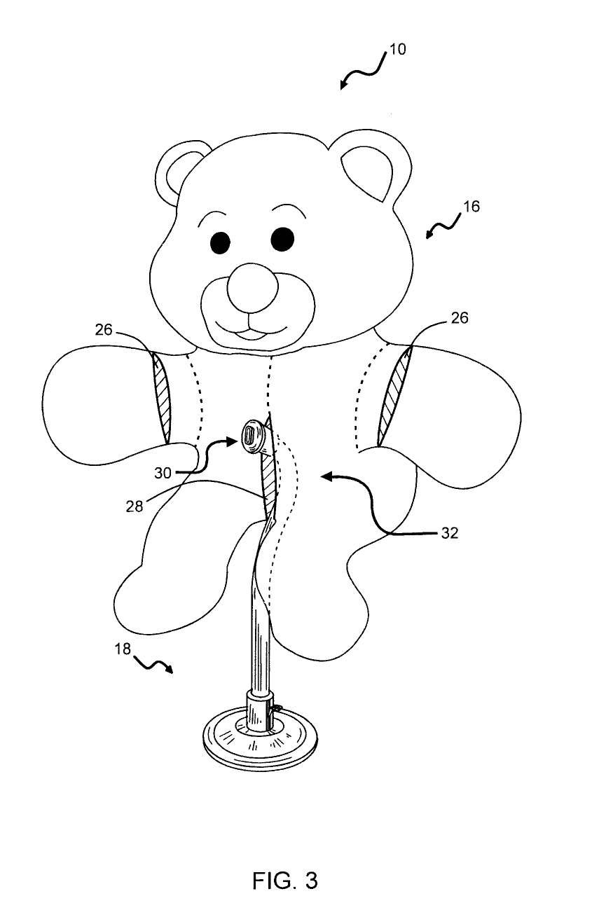

Referring to FIG. 3, a perspective view of a themed component 16 of a portable electronic device holder 10 and an attachment means 18 is illustrated. The attachment means 18 allows the electronic device holder 10 to fit against a surface. The themed component 16 may be a toy or a stuffed animal or cartoon character. In the preferred embodiment the themed component 16, illustrated as a teddy bear, includes at least one pocket 26 for receiving at least one arm portion 20 of a media holder 12. The themed component 16 further includes at least one slit 28 that is sewn into a mid section of the teddy bear 32. The at least one slit 28 is adaptable to receive the at least one top area 30 of the attachment means 18. The at least one top area 30 of the attachment means 18 slides through the slit 28 and into the back of the media holder 12 for maintaining the media holder 12 firmly onto the themed component 16. The themed component 16 may be made of plush, plastic, molded rubber material, or the like.

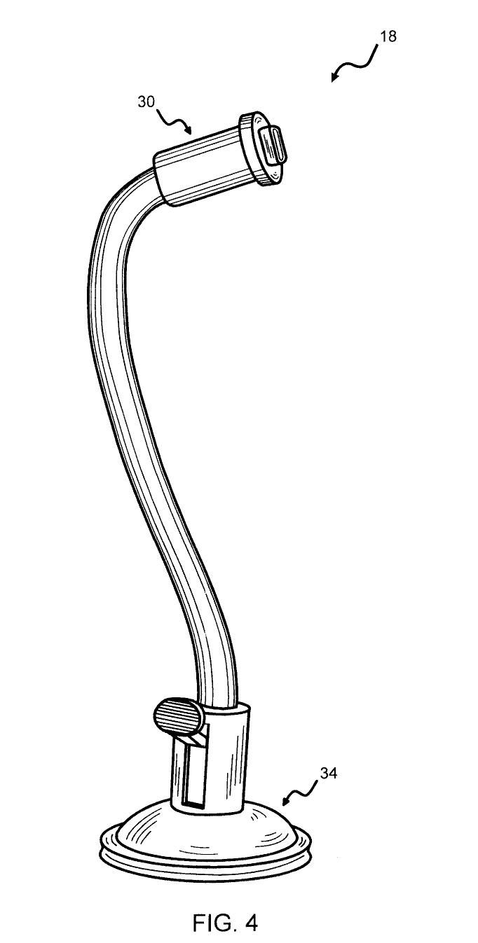

FIG. 4 illustrates at least one base portion 24 of a media holder 12 for supporting at least one electronic device 14. The at least one base portion 24 fits into the bottom of the media holder 12, and the at least one electronic device 14 rests on a top surface 34 of the at least one base portion 24. The top surface 34 may include a rubber portion 36 on which the at least one electronic device 14 rests when inserted inside the media holder 12 to allow for a secure fit of the at least one electronic device 14 into the media holder 12.

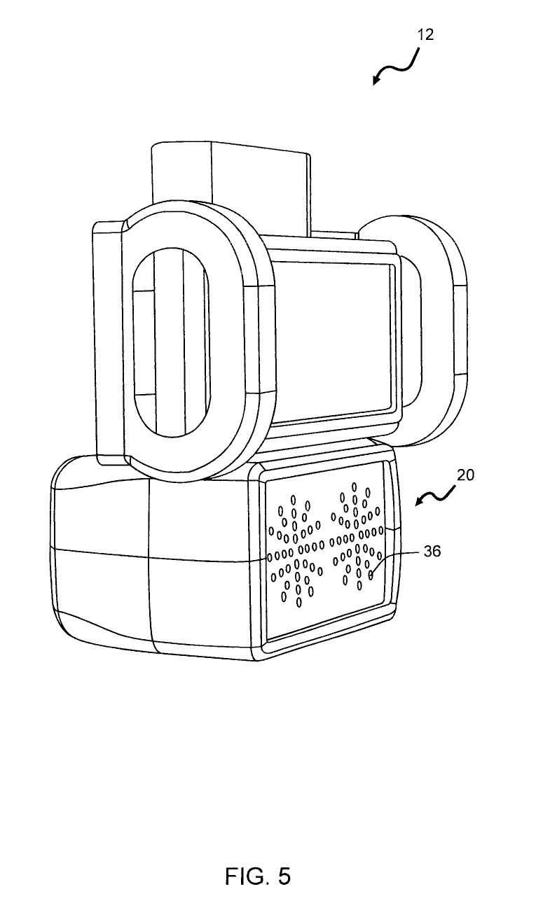

Referring to FIG. 5, a perspective view of at least one base portion 24 configured to hold an external speaker system 38 that plugs into at least one electronic device 14 is illustrated. The speaker system 38 includes at least one mini-speaker 40 attached to the base portion 24 and at least one speaker wire 42. The at least one speaker wire 42 runs along inside of the at least one base portion 24 through a canal 44 to prevent the at least one speaker wire 42 from interfering with the snug fit with the media holder 12. The at least one speaker wire 42 includes a plug 46 that plugs into the at least one electronic device 14. The at least one base portion 24 is adaptable to attach with the media holder 12 by means of clamps, screws, adhesive, or the like.

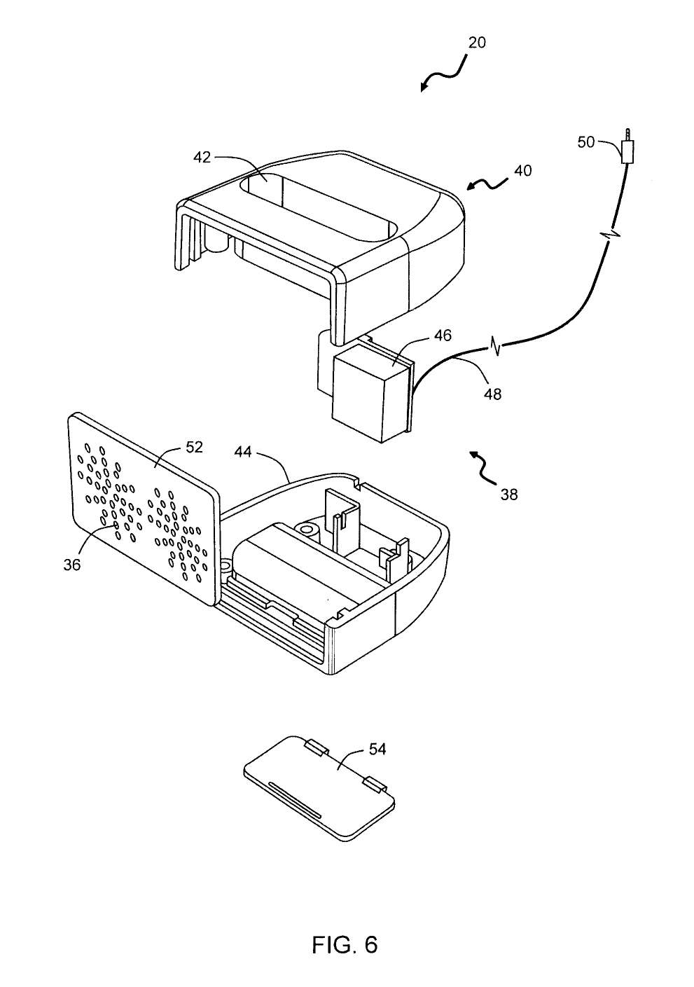

FIG. 6 illustrates an attachment means 18 for a portable electronic device holder 10. The attachment means 18 includes at least one base area 48 that allows the portable electronic device holder 10 to fit firmly against a surface. The at least one base area 48 may be interchangeable and is adaptable to attach with child transportation and carrying devices, furniture, bike trailers, car seats, tables, trays and other items involving portability and entertainment. The at least one base area 48 may be a suction cup, strap, cup holder attachment, clamp or the like. The attachment means 18 further includes at least one top area 30 that is adaptable to connect with a media holder 12. The attachment means 18 may have different designs, and therefore may be interchangeable, depending upon the surface onto which the portable electronic device holder 10 is attached.

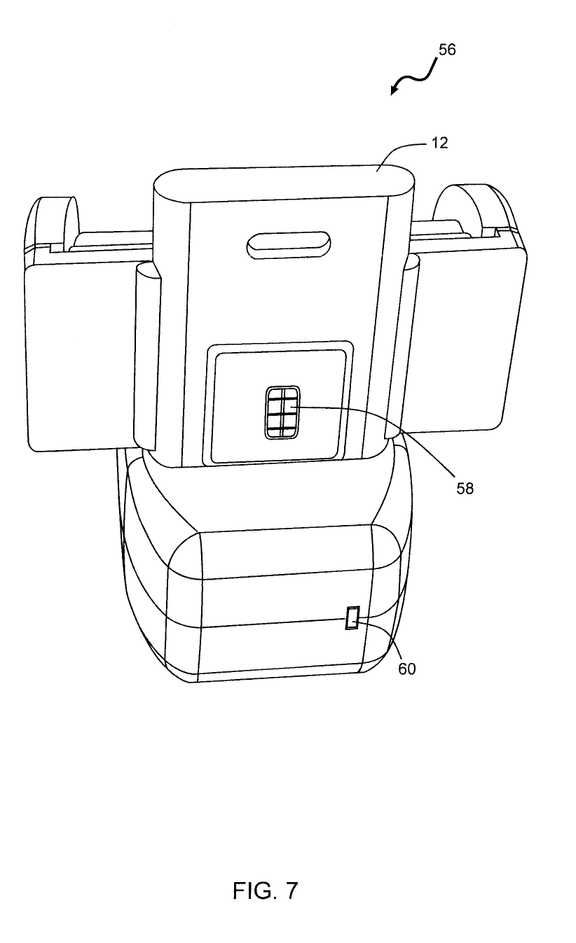

FIG. 7 illustrates a back portion 50 of a media holder 12. The back portion 50 includes a connecting area 52 that is designed to connect with at least one top area 30 of an attachment means 18 thereby allowing the media holder 12 to fit firmly into the themed component 16.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understooa that the present invention has been described by way of illustration and not limitation.

What is claimed is:

1. A portable electronic device holder, comprising:
a media holder for securing at least one electronic device therein;
a themed component adaptable to receive the media holder; and
an attachment means connected to the media holder for allowing the portable electronic device holder to fit against a surface;
whereby the themed component may be a favorite character for providing a friendly appearance to the portable electronic device holder and entertainment to at least one user.

2. The electronic device holder of claim 1, wherein the media holder comprises at least one arm portion that is adjustable to hold the at least one electronic device.

3. The electronic device holder of claim 1, wherein the media holder further comprises at least one neck portion designed to bend into multiple positions thereby providing an easy view of the at least one electronic device from different angles.

4. The electronic device holder of claim 1, wherein the media holder further comprises at least one base portion that supports the at least one electronic device on a top surface thereon.

5. The electronic device holder of claim 4, wherein the top surface comprises a rubber portion for a secure fit of the electronic device in the media holder.

6. The electronic device holder of claim 4, wherein the at least one base portion is configured to hold an external speaker system that plugs into the at least one electronic device.

7. The electronic device holder of claim 4, wherein the at least one base portion is designed to attach with the media holder by means of clamps, screws, adhesive, or the like.

8. The electronic device holder of claim 1, wherein the attachment means includes at least one base area that allows the portable electronic device holder to fit firmly against a surface.

9. The electronic device holder of claim 8, wherein the at least one base area may be a suction cup, strap, cup holder attachment, clamp or the like.

10. The electronic device holder of claim 8, wherein the at least one base area is interchangeable and adaptable to attach with items involving portability or entertainment, including child transportation and carrying devices, furniture, bike trailers, car seats, tables, and trays.

11. The electronic device holder of claim 1, wherein the attachment means further comprises at least one top area that is adaptable to connect with a back portion of the media holder.

12. The electronic device holder of claim 1, wherein the themed component comprises at least one pocket for receiving the at least one arm portion of the media holder.

13. The electronic device holder of claim 1, wherein the themed component further includes at least one slit that is adaptable to receive the at least one top area of the attachment means.

14. The electronic device holder of claim 1, wherein the at least one electronic device is a media player, including an iPod or cell phone.

15. The electronic device holder of claim 1, wherein the themed component is a toy or stuffed animal or cartoon character.

16. The electronic device holder of claim 1, wherein the themed component is made of plush, plastic or molded rubber material.

17. The electronic device holder of claim 1, wherein the at least one electronic device is secured to the media holder by means of an adhesive.

18. The electronic device holder of claim 1, wherein the media holder comprises a connecting area that is designed to connect with the at least one top area of the attachment means.

19. The electronic device holder of claim 1, wherein the attachment means is interchangeable depending upon the surface onto which the portable electronic device holder is attached.

20. A method of securing a themed component on a media holder comprised of the following steps:
(a) inserting an attachment means through a slit on the themed component;
(b) securing the attachment means to the connecting area of a media holder; and
(c)inserting at least one arm portion of a media holder into at least one pocket of the themed component.
